(19) United States
(12) Patent Application Publication
(10) Pub. No.: US 2008/0068655 A1
(43) Pub. Date: Mar. 20, 2008

(54) DATA PROCESSING APPARATUS AND RECORDING MEDIUM

(76) Inventor: Jun Kimura, Tokyo (JP)

Correspondence Address: DICKSTEIN SHAPIRO LLP, 1825 EYE STREET NW, Washington, DC, 20006-5403, US

(21) Appl. No.: 11/852,941

(22) Filed: Sep. 10, 2007

(30) Foreign Application Priority Data
Sep. 14, 2006 (JP) 2006-250038
Jun. 7, 2007 (JP) 2007-152025

(51) Int. Cl. G06K 15/02

(52) U.S. Cl. 358/1.16

(57) ABSTRACT

The present invention discloses a data processing apparatus for generating data that can be processed by a printing apparatus. The data processing apparatus includes a data storing part for storing function setting data related to a function of the printing apparatus, a data structure allocating part for obtaining the function setting data from the data storing part, reserving a first space in a data structure configured to store printing settings of the printing apparatus therein, and allocating a printing setting value to the space based on the obtained function setting data, and a data generating part for generating data processable for the printing apparatus based on the printing setting value allocated in the data structure by the data structure allocating part by referring to the function setting data stored in the data storing part.

### BACKGROUND OF THE INVENTION

1. Field of the Invention

The present invention relates to a data processing apparatus for generating data processable for a printing apparatus and a recording medium on which a program is recorded for causing a data processing apparatus to execute a data processing method for generating data processable for a printing apparatus.

2. Description of the Related Art

In a case where a data processing apparatus such as a personal computer (hereinafter also referred to as “PC”) is network-connected or serial-connected to a peripheral device (e.g., a printer, a scanner, a facsimile machine), the PC uses a device driver for converting data generated or browsed by an application installed in the PC into data that can be processed by the peripheral device. For example, in a case of using an image forming apparatus (hereinafter also simply referred to as “printer”) such as a laser printer (LP) or a multifunction printer (MFP), a printer driver dedicated for the printer is usually installed in a PC. Thereby, data generated or browsed by an application in the PC can be converted into printer language (PDL) data that can be processed by the printer.

However, there may be a case where the process of installing a device driver in a PC is restricted to only a specific administrator for realizing appropriate network management. Furthermore, the installing of the device driver may require complicated procedures. Moreover, in a case of installing a new printer driver in a printer(s) of a company where a printing operation is vital to the company's business, various tests are performed on the printer driver prior to placing the printer driver into actual use for determining whether it can perform basic printing processes inside and outside the company. Meanwhile, in a case of expanding (adding) functions of a device driver which is already installed in a PC, the functions of the device driver are usually expanded (added) by re-installing a new device driver having the expanded (additional) functions. Therefore, the administrator in charge of installing device drivers may need to go through complicated procedures and also execute various tests whenever a function of a device is expanded (added). Such installing process could be a heavy workload for the user including the administrator.

Meanwhile, in a case of a typical program, a new function can be added without having to re-install a basic program by using a method called plug-in. However, in a case of a device driver (e.g., printer driver), since the internal configuration of the device driver is constrained by the OS (Operating System) and cannot be freely designed as a typical program, the plug-in method cannot be used for a device driver.

For example, in a case where the OS of a printer is Windows (registered trademark), the printer driver is defined by a data structure called a DEVMODE having a configuration divided into a user-interface (UI) part for displaying a screen for allowing the user to set printing conditions (printing settings) and a graphic part for converting data (e.g., data generated by an application of a PC) into printing data and applying the printing conditions (printing settings) to the printing data, to thereby allow the graphic part to receive various conditions set in the user-interface part. The DEVMODE data structure includes a public part which can be shared by the OS and a private part which can be defined independently with respect to the vendor. Although it is possible to add a function by changing the private part, once the printer driver is installed the private part cannot be changed since the structure of the DEVMODE becomes fixed when the printer driver is installed.

Japanese Laid-Open Patent Application No. 2006-113812 (Patent Document 1) discloses a driver program for facilitating a host apparatus in a case of changing the functions of an image forming apparatus. This driver program has every anticipated function installed beforehand and displays only the functions required by the image forming apparatus.

Furthermore, Japanese Laid-Open Patent Application No. 2004-326601 (Patent Document 2) discloses a printing control apparatus capable of adding, updating, and deleting a function used in a printing process. By using a plug-in module connected to a driver main body module, the printing control apparatus can add a new printer function, update an existing printing function in exchange of a new printer function, and/or delete a printer function.

However, with Patent Documents 1 and 2, addition of functions after installation of a printer driver is performed by adding and deleting functions from a list prepared beforehand. In a case of adding a function that is not listed in the list, the art disclosed in Patent Documents 1 and 2 require re-installation of the printer driver. Furthermore, Patent Documents 1 and 2 do not describe how the disclosed art is applied to a data structure defined by the operating system (OS) such as the DEVMODE. Therefore, the methods of Patent Documents 1 and 2 are liable to face various problems when adding a function to such data structure.

### SUMMARY OF THE INVENTION

The present invention may provide a data processing apparatus and a recording medium that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a data processing apparatus and a recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a data processing apparatus for generating data that can be processed by a printing apparatus, the data processing apparatus including: a data storing part for storing function setting data related to a function of the printing apparatus; a data structure allocating part for obtaining the function setting data from the data storing part, reserving a first space in a data structure configured to store printing settings of the printing apparatus therein, and allocating a printing setting value to the space based on the obtained function setting data; and a data generating part for generating data processable for the printing apparatus based on the printing setting value allocated in the data structure by the data structure allocating part by referring to the function setting data stored in the data storing part.

Furthermore, another embodiment of the present invention provides a recording medium on which a program is recorded for causing a data processing apparatus to execute a data processing method for generating data that can be processed by a printing apparatus, the data processing method including the steps of: a) storing function setting data related to a function of the printing apparatus; b) obtaining the function setting data from the data storing part, reserving a first space in a data structure configured to store printing settings of the printing apparatus therein, and allocating a printing setting value to the space based on the obtained function setting data; and c) generating data processable for the printing apparatus based on the printing setting value allocated in the data structure by the data structure allocating part by referring to the function setting data stored in the data storing part.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary network configuration of a data processing system according to an embodiment of the present invention;

FIG. 2 is a schematic diagram showing an exemplary hardware configuration of the computer according to an embodiment of the present invention;

FIG. 3 is a schematic diagram showing an exemplary functional configuration of the computer according to an embodiment of the present invention;

FIG. 4 is a block diagram showing an exemplary configuration of a printer driver of a computer according to an embodiment of the present invention;

FIG. 5 is a table showing an example of a data description of function setting data stored in a function setting data DB according to an embodiment of the present invention;

FIG. 6 is a table showing an example of a data description of layout data stored in a layout data DB according to an embodiment of the present invention;

FIG. 7 is a sequence diagram for describing an exemplary operation of generating data with a computer according to an embodiment of the present invention;

FIG. 8 is a flowchart for describing an exemplary operation of allocating a process content to a DEVMODE structure with a computer according to an embodiment of the present invention;

FIGS. 9A-9E are schematic diagrams showing exemplary data structures of a DEVMODE structure according to an embodiment of the present invention;

FIG. 10 is a flowchart for describing an exemplary operation of determining a printer interpretable command from a DEVMODE structure with a computer according to an embodiment of the present invention;

FIG. 11 is a sequence diagram for describing an exemplary operation of generating data with a computer according to another embodiment of the present invention;

FIGS. 12A and 12B are schematic diagrams showing examples of a printing setting screen according to an embodiment of the present invention;

FIG. 13 is a sequence diagram for describing an exemplary operation of generating data with a computer according to another embodiment of the present invention;

FIG. 14 is a schematic diagram showing an example of a printing setting screen according to an embodiment of the present invention;

FIG. 15 is a sequence diagram for describing an exemplary operation of generating data with a computer according to another embodiment of the present invention;

FIG. 16 is a flowchart for describing an exemplary operation of generating data based on addition function data with a computer according to an embodiment of the present invention; and

FIG. 17 is a sequence diagram for describing an exemplary operation of generating data with a computer according to another embodiment of the present invention.

### DESCRIPTION OF THE PREFERRED EMBODIMENTS

In the following, embodiments of the present invention are described with reference to the accompanying drawings.

### [Configuration]

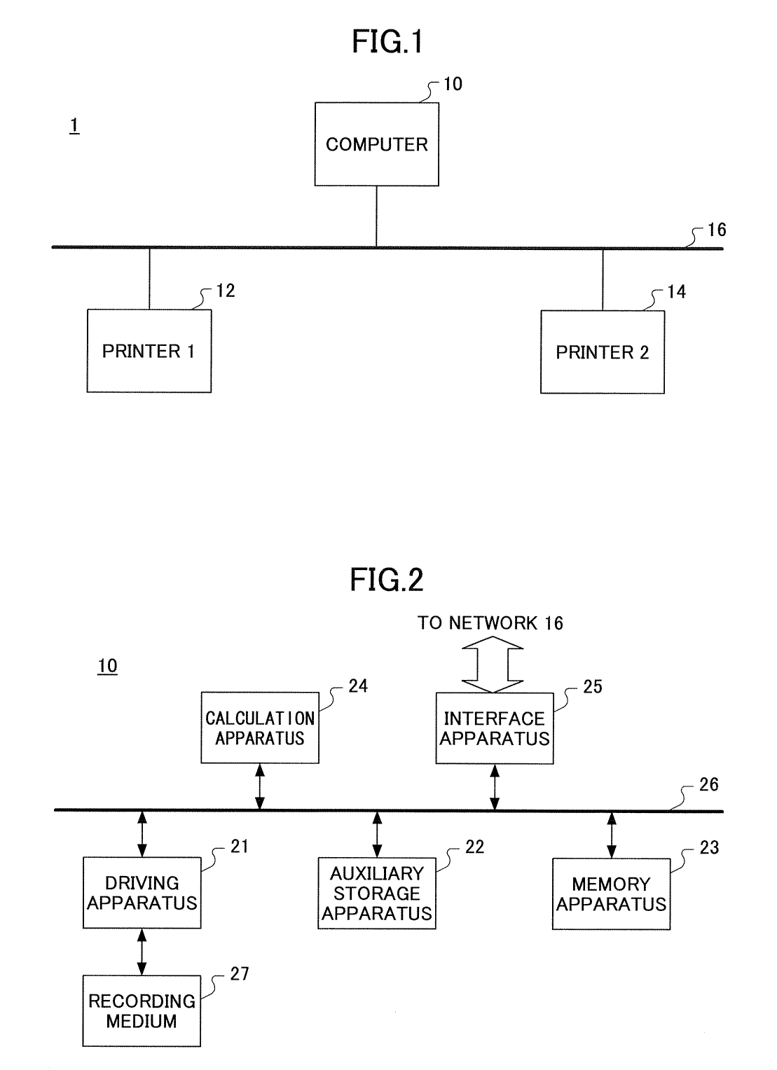

FIG. 1 is a schematic diagram showing an exemplary network configuration of a data processing system according to an embodiment of the present invention.

In FIG. 1, a data processing system 1 includes a computer (i.e. data processing apparatus) 10, first printer (printer 1) 12, a second printer (printer 2) 14, and a network 16 connecting the computer 10 and the first and second printers 12, 14 for enabling data communications.

The computer 10 according to an embodiment of the present invention includes an apparatus capable of displaying a user-interface based on an operating system (OS) such as a personal computer (PC), a PDA (Personal Digital Assistant), or a mobile phone.

The first and second printers 12, 14 are operable according to requests from the computer 10. In this example, the first and second printers 12, 14 may be a laser printer (LP) or a multifunction printer (MFP).

Although FIG. 1 shows one computer, one first printer, and one second printer, plural computers and plural first and second printers may be provided. Furthermore, the computer 10, the first printer 12, and the second computer 14 may be connected in the form of a network connection (e.g., LAN (Local Area Network), the Internet) or in the form of a serial connection (e.g., USB).

FIG. 2 is a schematic diagram showing an exemplary hardware configuration of the computer 10 according to an embodiment of the present invention. As shown in FIG. 2, the computer 10 includes a drive apparatus 21, an auxiliary storage apparatus 22, a memory apparatus 23, a processing apparatus (e.g., arithmetic processing apparatus) 24, and an interface apparatus 25 which are connected to a bus 26. A program for realizing processes and functions of the computer 10 may be provided in a recording medium (e.g., CD-ROM) 27.

The drive apparatus 21 is for reading a program recorded in the recording medium 27. When the recording medium 27 having the program recorded thereto is placed in the drive apparatus 21, the program is installed in the auxiliary storage apparatus 22 via the drive apparatus 21. Although the program recorded in the recording medium 27 may be various types of device drivers (e.g., printer driver, PC-FAX driver), the below-described embodiment of the present invention is explained in an exemplary case where the program is a printer driver.

The auxiliary storage apparatus 22 is for storing an installed program therein and also for storing various files and data. The memory apparatus 23 is for reading out a program from the auxiliary storage apparatus 22 and storing the program in a case where there is an instruction to activate (start) the program. The processing apparatus 24 is for executing functions related to the computer 10 in accordance with the program stored in the memory apparatus 23. The interface apparatus 25 is for connecting the computer 10 to the network 16 shown in FIG. 1.

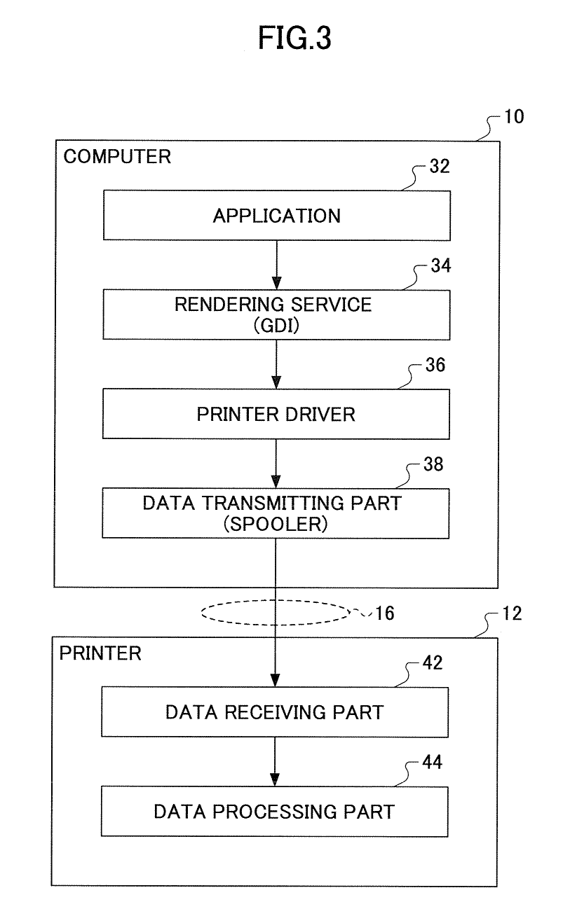

FIG. 3 is a schematic diagram showing a exemplary functional configuration of the computer 10. As shown in FIG. 3, the computer 10 is connected to the printer 12 via the network 16. The computer 10 includes an application 32, a rendering service 34, a printer driver 36, and a data transmitting part 38.

The application 32 according to an embodiment of the present invention is a program operable on an OS such as Windows (Registered Trademark). For example, the application 32 may be a general purpose application such as word processing software or spreadsheet software.

The rendering service 34 is a rendering engine operable on the OS. The rendering service 34 is typically included in a GDI (Graphic Device Interface) together with an interface for connecting the application 32 and the rendering service 34.

The printer driver 36 is a module for converting internal commands of the OS into data that can be processed by the printer 12 (printer processable data). The printer processable data include, for example, printer language (PDL, Page Description Language) data. The printer driver 36 is typically connected to the rendering service (GDI) 34 via an interface called a DDI (Device Driver Interface).

The data transmitting part 38 is a so-called spooler, that is, a module for spooling PDL data generated in the printer driver 36. The PDL data spooled by the data transmitting part (spooler) 38 is transmitted to the printer 12 via the network 16.

The printer 12 is an apparatus for printing data generated or browsed in the computer 10. The printer 12 includes a data receiving part 42 for receiving PDL data transmitted from the data transmitting part 38 of the computer 10 and a data processing part 44 for processing the PDL data received in the data receiving part 42 and printing the processed data.

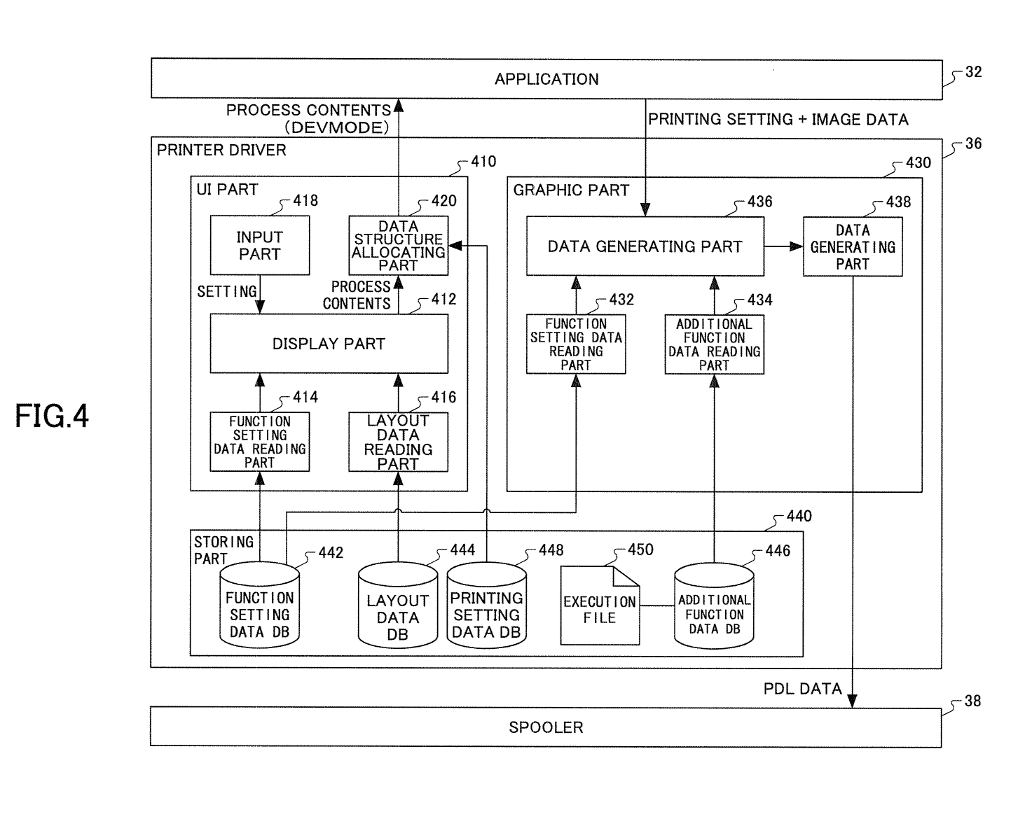

FIG. 4 is a block diagram showing an exemplary configuration of the printer driver 36 of the computer 10 according to an embodiment of the present invention. As shown in FIG. 4, the printer driver 36 includes a user-interface (UI) part 410, a graphic part 430, and a data storing part 440.

The UI part 410 is for setting printing conditions of the printer 12 according to input by the user. The UI part 410 includes a display part 412, a first function setting data reading part 414, a layout data reading part 416, an input part 418, and a data structure allocating part 420.

The display part 412 generates a screen (printing setting screen) for allowing printing conditions of the printer 12 to be set and displays the generated screen on a display apparatus (not shown) such as a monitor. The display part 412 sets the process content(s) of printing conditions of the printer 12 by receiving printing setting data input by the user. It is to be noted that “process content(s)” include, for example, data related to initialization of devices and data related to printer environment. The process contents are stored in a data structure called the DEVMODE structure.

The first function setting data reading part 414 is for reading function setting data used in the display part 412 from the data storing part 440. It is to be noted that “function setting data” include, for example, device configuration data of the printer 12 and file data having command data corresponding to the device configuration data.

The layout data reading part 416 is for reading layout data used for the display part 412 from the data storing part 440. It is to be noted that “layout data” include, for example, the layout of the UI of the printing setting screen displayed by the display part 412.

The input part 418 is for receiving various setting data from the user via an input apparatus such as a mouse or a keyboard.

The data structure allocating part 420 is for allocating process contents set by the display part 412 to a predetermined data structure (in this example, DEVMODE).

The graphic part 430 is for converting data (e.g., document data) generated or browsed in the application 32 into data that can be processed by the printer 12 (printer processable data) in accordance with the process contents set by the UI part 410. The graphic part 430 includes a second function setting data reading part 432, an additional function data reading part 434, an output command determining part 436, and a data generating part 438.

The same as the first function setting data reading part 414, the second function setting data reading part 432 is for reading function setting data from the data storing part 440.

The additional function data reading part 434 is for reading additional function data of the printer driver 36. It is to be noted that “additional function data” includes, for example, data related to a function(s) added to the printer driver 36 after the installation of the printer driver 36.

The output command determining part 436 is for determining a printer interpretable command (i.e. command that can be interpreted by the printer 12) corresponding to the process contents set by the UI part 410 by referring to the function setting data read by the second function setting data reading part 432 and the additional function data read by the additional function data reading part 434.

The data generating part 438 is for generating PDL data that can be processed by the printer 12 by converting data (e.g., document data) generated or browsed by the application 32 based on the command determined by the output command determining part 436. The PDL data generated by the data generating part 438 are transmitted to the spooler 38.

The data storing part 440 is for storing data used by the UI part 410 and the graphic part 430. The data storing part 440 includes a function setting data database (DB) for storing function setting data, a layout data DB for storing layout data, an additional function data DB 446 for storing additional function data as function execution files 450, and a printing setting data DB 448 for storing process contents which are set as a default or process contents which are set at a previous printing operation.

### [Example of Data Description of Function Setting Data]

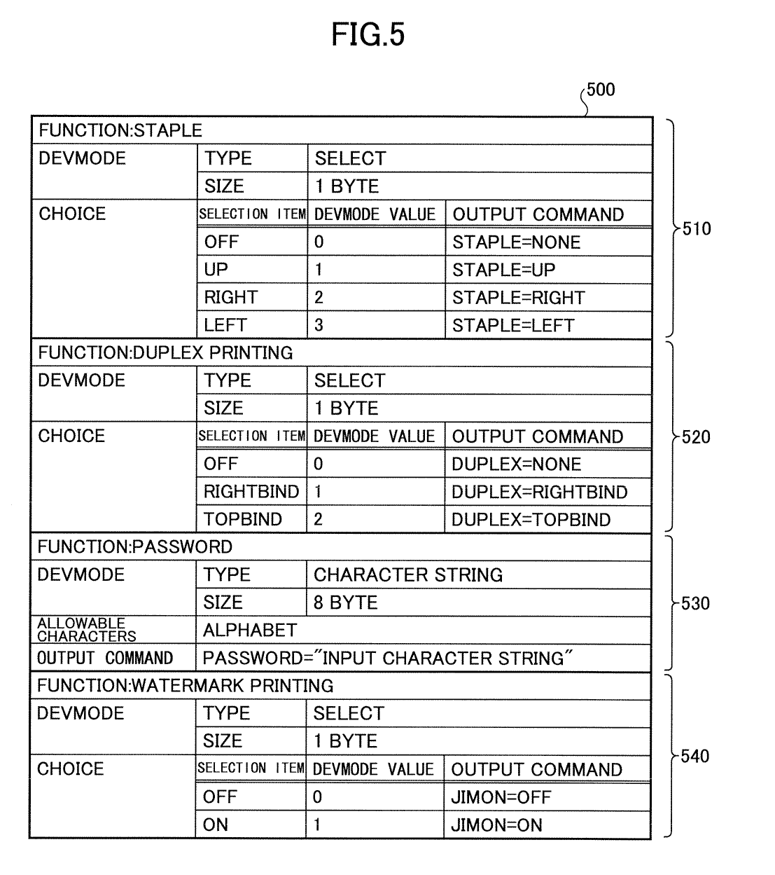

FIG. 5 is a table showing an example of a data description of function setting data 500 stored in the function setting data DB 442 shown in FIG. 4. As shown in FIG. 5, the function setting data 500 include first, second, third, and fourth function data 510, 520, 530, 540. The first, second, third, and fourth function data 510, 520, 530, 540 each include data related to, for example, the name of a function (function name) that can be executed by the printer 12, the data format in the DEVMODE structure, and options that can be selected.

The first function data 510 include data related to a staple function. The name of the function of the first function data 510 is “staple”. Since the staple function can be set by selecting a choice from a number of choices, the data format in the DEVMODE structure includes data “select” as a type of setting method. Furthermore, the data format in the DEVMODE structure includes data “one byte” as the data size of the DEVMODE structure. The data size of the DEVMODE structure indicates the size required for writing the setting data in the DEVMODE structure in a case where the staple function is set by the selection of one of the choices. The first function data 510 according to an embodiment of the present invention include four choices which are “Off”, “Up”, “Right”, and “Left”. When one of the choices is selected, the selected choice is associated to a value written in the DEVMODE structure and a printer interpretable command corresponding to the selected choice.

The second function data 520 include data related to a duplex printing function. The name of the function of the second function data 520 is “duplex printing”. The same as the first function data 510, since the duplex printing function can be set by selecting a choice from a number of choices, the data format in the DEVMODE structure includes data “select” as a type of setting method. Furthermore, the data format in the DEVMODE structure includes data “one byte” as the data size of the DEVMODE structure. The second function data 520 according to an embodiment of the present invention includes three choices which are “Off”, “Right-bind”, and “Left-bind”. The same as the first function data 510, when one of the choices is selected, the selected choice is associated with a value written in the DEVMODE structure and a printer interpretable command corresponding to the selected choice.

The third function data 530 include data related to a password function. The name of the function of the third function data 530 is “password”. Since the password function can be set by a character string input by the user, the data format in the DEVMODE structure includes data “character string” as a type of setting method. Furthermore, the data format in the DEVMODE structure includes data regarding the data size of the DEVMODE structure, that is, data size of the character string input by the user. For example, in a case where one character equals to one byte, the data of the data size is “eight bytes” in a case where the password is a character string consisting of eight characters. Furthermore, the data format in the DEVMODE structure includes data regarding the type of character that can be input as the password. For example, in a case where the type of character that can be input as the password is alphabet only, the data format in the DEVMODE structure includes data “alphabet” as the type of character that can be input as the password. The third function data 530 also includes data of printer interpretable commands corresponding to the password function.

The fourth function data 540 include data related to a watermark printing function. The name of the function of the fourth function data 540 is “watermark printing”. The same as the first function data 510, since the watermark printing function can be set by selecting a choice from a number of choices, the data format in the DEVMODE structure includes data “select” as a type of setting method. Furthermore, the data format in the DEVMODE structure includes data “one byte” as the data size of the DEVMODE structure. The fourth function data 540 according to an embodiment of the present invention includes two choices which are “Off” and “On”. The same as the first function data 510, when one of the choices is selected, the selected choice is associated with a value written to the DEVMODE structure and a printer interpretable command corresponding to the selected choice.

### [Example of Data Description of Layout Data]

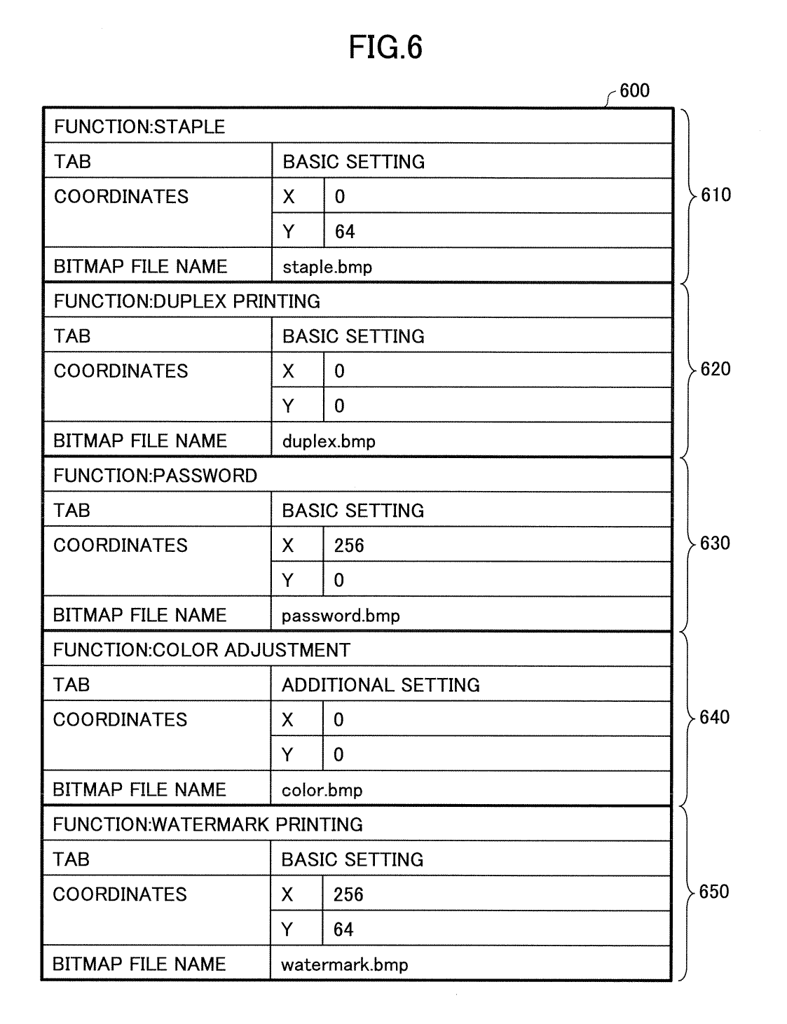

FIG. 6 is a table showing an example of a data description of layout data 600 stored in the layout data DB 44 shown in FIG. 4. As shown in FIG. 6, the layout data 600 include first, second, third, fourth, and fifth layout data 610, 620, 630, 640, 650. The first, second, third, fourth, and fifth layout data 610, 620, 630, 640, 650 each include data related to, for example, name of a function (function name), data input space, layout of function image (display tab and coordinates), and file names of the function image which are to be displayed on the setting screen.

The first layout data 610 include data related to the staple function. The name of the function of the first layout data 610 is “staple”. The first layout data 610 describe a setting input space corresponding to the staple function as being positioned with coordinates (X,Y)=(0,64) in a “basic setting” tab which is to be displayed in the printing setting screen. The first layout data 610 also describe a function image corresponding to the staple function as being obtained from an image file having a file name “staple. bmp”.

The second layout data 620 include data related to the duplex printing function. The name of the function of the second layout data 620 is “duplex printing”. The second layout data 620 describe a setting input space corresponding to the duplex printing function as being positioned with coordinates (X,Y)=(0,0) in a “basic setting” tab which is to be displayed in the printing setting screen. The second layout data 620 also describe a function image corresponding to the duplex printing function as being obtained from an image file having a file name “duplex. bmp”.

The third layout data 630 include data related to the password function. The name of the function of the third layout data 630 is “password”. The third layout data 630 describe a setting input space corresponding to the password function as being positioned with coordinates (X,Y)=(256,0) in a “basic setting” tab which is to be displayed in the printing setting screen. The third layout data 630 also describe a function image corresponding to the password function as being obtained from an image file having a file name “password. bmp”.

The fourth layout data 640 include data related to the color adjustment. The name of the function of the fourth layout data 640 is “color adjustment”. The fourth layout data 640 describe a setting input space corresponding to the color adjustment function as being positioned with coordinates (X,Y)=(0,0) in a “additional function” tab which is to be displayed in the printing setting screen. The fourth layout data 640 also describe a function image corresponding to the color adjustment function as being obtained from an image file having a file name “color. bmp”.

The fifth layout data 650 include data related to the watermark function. The name of the function of the fifth layout data 650 is “watermark printing”. The fifth layout data 650 describe a setting input space corresponding to the watermark printing function as being positioned with coordinates (X,Y)=(256,64) in a “basic setting” tab which is to be displayed in the printing setting screen. The fifth layout data 650 also describe a function image corresponding to the watermark function as being obtained from an image file having a file name “watermark. bmp”.

It is to be noted that, although the above-described function setting data 500 and the layout data 600 may be described in a table format as shown in FIGS. 5 and 6, the function setting data 500 and the layout data 600 may be described using other formats. Although the function setting data 500 shown in FIG. 5 include four kinds of function data, the kinds of function data may be greater than or less than four kinds. Although the layout data 600 shown in FIG. 6 include five kinds of layout data, the kinds of layout data 600 may be greater than or less than five kinds.

The function setting data 500 and the layout data 600 to be stored in the computer 10 may be directly input from the user, read out from a recording medium, obtained from a predetermined server, or obtained from the printer 12. For example, in a case of obtaining the function setting data 500 and the layout data 600 from the printer 12, the printer 12 may transmit the function setting data 500 and the layout data 600 to the computer 10 upon receiving an activation request from the computer 10.

Next, operation of the printer driver 36 shown in FIG. 4 is described in an exemplary case where the function setting data 500 and the layout data 600 include data shown in FIGS. 5 and 6.

### First Embodiment

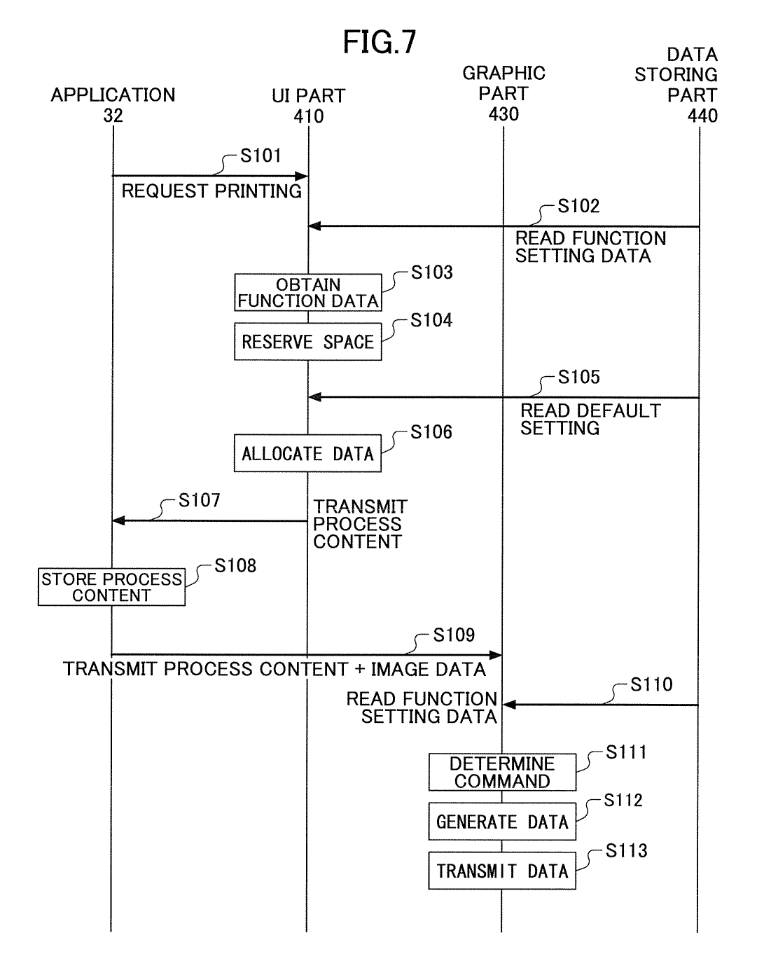

With reference to the sequence diagram of FIG. 7, an operation of the computer 10 is described in a case where default process contents or process contents which were set in a previous printing operation are used when generating data that can be processed by the printer 12.

As an exemplary case of using default process contents or process contents used in a previous operation, there is a case where a user requests a printing operation to the printer driver 36 by pressing a printer icon displayed on a screen when an application 32 is in operation. In this case, a printing case is transmitted from the application 32 to the printer driver 36 (Step S101).

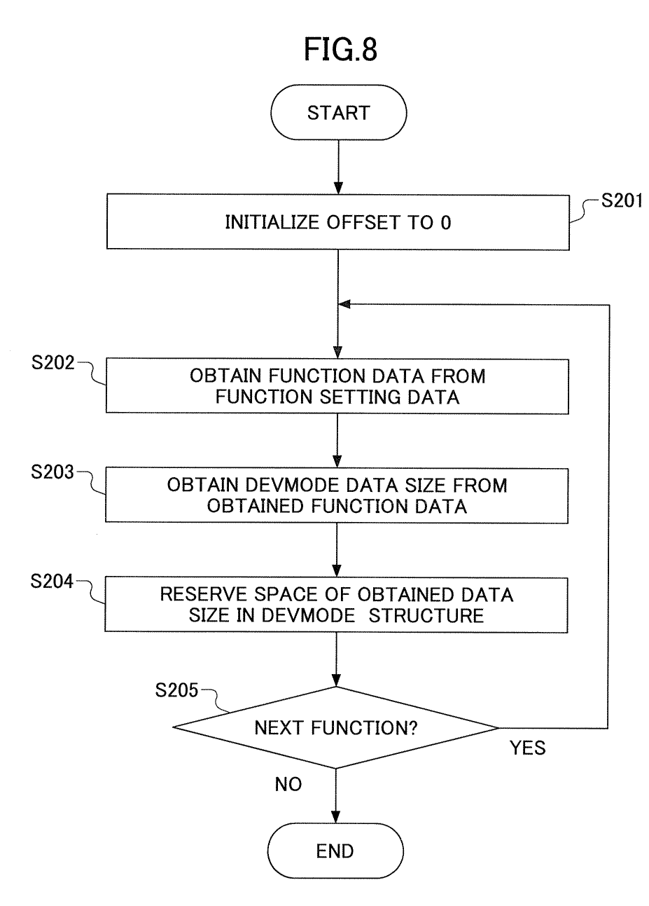

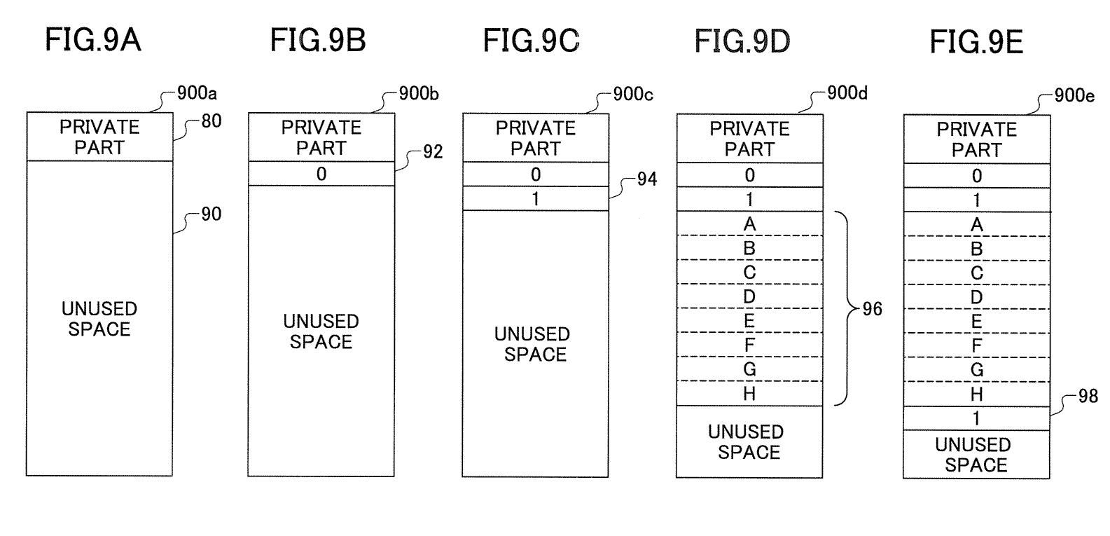

Upon receiving the printing request, the UI part 410 reads function setting data 500 (See FIG. 5) from the function setting data DB 442 of the data storing part 440 by using the first function setting data reading part 414 (Step S102). Then, the UI part 410 with use of the data structure allocating part 420 obtains function data related to the various functions from the function setting data 500 read by the first function setting data reading part 414 (Step S103), obtains the data size for storing the process contents corresponding to the various functions in the DEVMODE structure, and reserves a space corresponding to the obtained data size in the DEVMODE structure (Step S104). In a case where function setting data that have not yet been read by the first function setting data reading part 414 remain in the data storing part 440, the above-described Steps S102 through S104 are repeated. The process of reserving a space in the DEVMODE structure is described in detail with reference to FIGS. 8 and 9.

After the space is reserved in the DEVMODE structure, the UI part 440 with use of the data structure allocating part 420 reads default settings corresponding to the process contents from the printing setting data DB 448 of the data storing part 440 (Step S105) and allocates the default settings in the DEVMODE structure (Step S106).

The UI part 410 with use of the data structure allocating part 420 transmits the DEVMODE structure containing the default settings as the process contents to the application 32 (Step S107). The application 32 temporarily stores the DEVMODE structure transmitted from the UI part 410 (Step S108) and transmits the DEVMODE structure together with image data generated or browsed by the application 32 to the graphic part 430 of the printer driver 36 (Step S109).

The graphic part 430 with use of the second function setting data reading part 432 reads function setting data 500 from the function setting data DB 442 of the data storing part 440 (Step S110). The graphic part 430 with use of the command determining part 436 determines the printer interpretable command (command that can be interpreted by the printer 12) corresponding to the default settings allocated to the DEVMODE structure obtained from the application 32 by referring to the function setting data 500 read by the second function setting data reading part 432 (Step S111). The graphic part 430 with use of the data generating part 438 generates printer processable data (data that can be processed by the printer 12) from the image data obtained from the application 32 and the default data allocated to the DEVMODE structure in accordance with the command determined by the command determining part 436 (Step S112). Then, the graphic part 430 transmits the data generated by the data generating part 438 to the printer 12 via the spooler 38 shown in FIG. 3 (Step S113).

Next, the process of reserving a space in the DEVMODE structure is described in further detail with reference to FIG. 8.

In one example, a printing requests triggers the data structure allocating part 420 to initialize the offset of the DEVMODE structure to 0 (Step S201). Then, the data structure allocating part 420 obtains first function data from the function setting data 500 read by the first function setting data reading part 414 (Step S202). The data structure allocating part 420 obtains the data size necessary for writing the process contents (process contents set to the function of the function data) in the DEVMODE structure (Step S203). Then, the data structure allocating part 420 reserves a space corresponding to the data size obtained from offset of the DEVMODE structure (Step S204).

Then, the data structure allocating part 420 determines whether there are any function data which have not been obtained in the function setting data 500 (Step S205). In a case where there are still function data remaining (Yes in Step S205), the above-described Steps S202 through S204 are repeated after the previously obtained data size is added to the current offset. In a case where there are no function data remaining (No in Step S205), the data allocating part 420 ends the process of reserving a space in the DEVMODE structure.

Next, the process of allocating process contents to the above-described DEVMODE structure is described in further detail with reference to FIG. 9.

FIG. 9 shows an example of a data structure of the DEVMODE structure according to an embodiment of the present invention. The DEVMODE structure typically includes a public part which can be shared by the OS and a private part which can be defined independently with respect to the vendor. The DEVMODE structure shown in FIG. 9 is a variable DEVMODE structure with an unused area 90 added which can have data added to, data deleted from, or data re-written in even after the printer driver is installed.

FIG. 9A shows a DEVMODE structure 900a in a state where no data is allocated to its unused space 90. The following describes a case of allocating process contents of functions defined by the function setting data 500 (See FIG. 5) to the DEVMODE structure 900a.

As described above with FIG. 8, the data structure allocating part 420 reserves a space for allocating process contents to the DEVMODE structure. The data structure allocating part 420, first, initializes the offset of the DEVMODE structure 900a to 0 (Step S201). In FIG. 9A, the offset of 0 is the border between the private part 80 and the unused space 90. Then, the data structure allocating part 420 obtains first function data 510 (in this example, staple function data) from the function setting data 500 read by the first function setting data reading part 414 (Step S202). Then, the data structure allocating part 420 obtains the data size necessary for writing the process contents of the staple function (in this example, “one byte”) to the DEVMODE structure (Step S203). As shown in FIG. 9B, the data structure allocating part 420 reserves a space 92 expanding from the offset 0 to a point where the space 92 becomes substantially equivalent to one byte. Then, the data structure allocating part 420 determines whether there are any remaining function setting data 500 (Step S205). As shown in FIG. 5, since the function setting data 500 further include second function data 520 (in this example, duplex printing function data), the data size of the space 92 reserved for writing the process contents of the staple function is added to the current offset 0. Accordingly, the new offset becomes “1”.

As shown in FIG. 5, the function setting data 500, in addition to the first function data 510 (in this example, staple function data) having their process contents allocated to the DEVMODE structure, include second, third, and fourth function data 520, 530, 540 related to the duplex printing function, the password function, and the watermark printing function. The data size necessary for allocating the process contents of the second function data 520 (in this example, duplex printing function data) is one byte. Accordingly, as shown in FIG. 9C, the data structure allocating part 420 reserves a space 94 in the DEVMODE structure 900b expanding from the offset 1 to a point where the space 94 becomes substantially equivalent to one byte, to thereby obtain DEVMODE structure 900c. Accordingly, the new offset becomes “2”. Likewise, the data size necessary for allocating the process contents of the third function data 530 (in this example, password function data) is eight bytes. Accordingly, as shown in FIG. 9D, the data structure allocating part 420 reserves a space 96 in the DEVMODE structure 900c expanding from the offset 2 to a point where the space 96 becomes substantially equivalent to eight bytes, to thereby obtain DEVMODE structure 900d. Accordingly, the new offset becomes “10”. Likewise, the data size necessary for allocating the process contents of the fourth function data 540 (in this example, watermark printing function data) is one byte. Accordingly, as shown in FIG. 9E, the data structure allocating part 420 reserves a space 98 in the DEVMODE structure 900d expanding from the new offset 10 to a point where the space 98 becomes substantially equivalent to one byte, to thereby obtain DEVMODE structure 900e.

Accordingly, after spaces in the DEVMODE structure have been reserved based on all of the function data included in the function setting data 500, the data structure allocating part 420 allocates corresponding process contents (in this example, default settings) to the reserved spaces.

For example, in a case where the default settings for the staple function is set with a choice “off”, the data structure allocating part 420 obtains a DEVMODE value “0” corresponding to the choice “off” from the first function data 510 obtained beforehand. Then, the data structure allocating part 420 writes the DEVMODE value “0” in the space 92 reserved in the DEVMODE structure 900b (See FIG. 9B) having a data size of one byte from the offset “0”.

Furthermore, in a case where, for example, the default settings for the duplex printing function is set with a choice “right-bind”, the data structure allocating part 420 obtains a DEVMODE value “1” corresponding to the choice “right-bind” from the second function data 520 obtained beforehand. Then, the data structure allocating part 420 writes the DEVMODE value “1” in the space 94 reserved in the DEVMODE structure 900c (See FIG. 9C) having a data size of one byte from the offset “1”.

Furthermore, in a case where, for example, the default settings for the password function is set with an eight alphabet letter character string “ABCDEFGH”, the data structure allocating part 420 writes the character string “ABCDEFGH” in the space 96 reserved in the DEVMODE structure 900d (See FIG. 9D) having a data size of eight bytes from the offset “2”.

Furthermore, in a case where, for example, the default settings for the watermark printing function is set with a choice “on”, the data structure allocating part 420 obtains a DEVMODE value “1” corresponding to the choice “on” from the fourth function data 540 obtained beforehand. Then, the data structure allocating part 420 writes the DEVMODE value “1” in the space 98 reserved in the DEVMODE structure 900e (See FIG. 9E) having a data size of one byte from the offset “10”.

Accordingly, the process contents corresponding to the function data included in the function setting data 500 of FIG. 5 can be allocated to the DEVMODE structure.

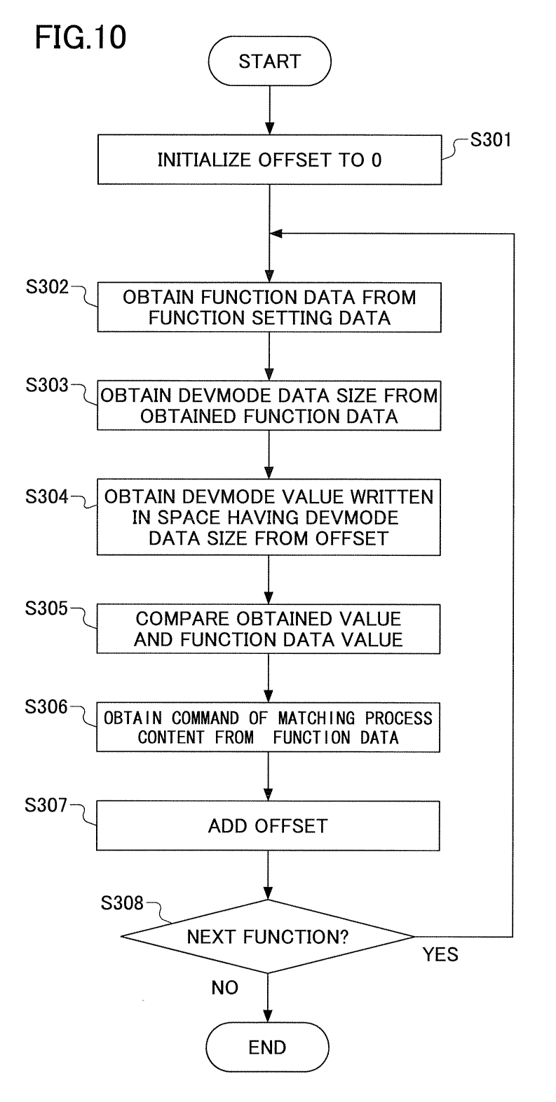

Next, the process (operation) of determining the printer interpretable command with respect to the DEVMODE structure including the allocated process contents is described with reference to FIG. 10.

After the graphic part 430 reads out function setting data 500 from the data storing part 440 (as shown in Step S110 of FIG. 7), the command determining part 436 initializes the offset of the DEVMODE structure to 0 (Step S301).

Then, the command determining part 436 obtains first function data from the function setting data 500 read by the second function setting data reading part 432 of the graphic part 430 (Step S302). The command determining part 436 obtains the data size necessary for writing the process contents of the function of the obtained function data to the DEVMODE structure 436 (Step S303). Then, the command determining part 436 obtains a DEVMODE value written in a space of the DEVMODE structure expanding from the offset 0 to a point where the space becomes substantially equivalent to the data size obtained in Step S303 (Step S304). Then, the command determining part 436 searches the process contents associated to the obtained DEVMODE value by referring to the function data obtained in Step S302 (Step S305) and determines the command associated to the process contents (Step S306). After determining the command, the command determining part 436 adds the data size obtained in Step S303 to the offset 0 (Step S307). The offset added with the obtained data size becomes the new offset.

The command determining part 436 determines whether there are any function data which are not yet obtained in the function setting data 500 (Step S308). In a case where there are function data remaining, the above-described Steps S302 to S307 are repeated. In a case where there are no function data remaining, the command determining part 436 ends the process of determining commands based on the DEVMODE structure.

Next, the process (operation) shown in FIG. 10 is described in further detail in a case of allocating the process contents defined by the function setting data 500 of FIG. 5 to the DEVMODE structure 900e as shown in FIG. 9E.

First, the command determining part 436 initializes the offset of the DEVMODE structure to 0 (Step S301). In FIG. 9E, the offset of 0 is the border between the private part 80 and the space 92 in which the process contents of the staple function are written.

Then, the command determining part 436 obtains the first function data (in this example, staple function data) 510 from the function setting data 500 read by the second function setting data reading part 432 (Step S302). Then, the command determining part 436 obtains the data size necessary for writing the process contents of the staple function (in this example, one byte) to the DEVMODE structure (Step S303). Then, the command determining part 436 obtains the DEVMODE value (in this example, “0”) written in the space 92 having a data size equivalent to one byte from the offset 0 of the DEVMODE structure 900e (Step S304). Then, the command determining part 436 searches for the process contents associated to the obtained DEVMODE value “0” by referring to the first function data 510 obtained in Step S302 (Step S305). As shown in FIG. 5, the process contents associated to the DEVMODE value “0” in the first function data 510 is the choice “off”. Accordingly, the command determining part 436 determines the command “STAPLE=NONE” as the command associated to the choice “off” of the first function data 510 (Step S306). After the command is determined, the command determining part 436 adds the data size of the space 92 (in this example, one byte) to the current offset 0 (Step S307). Thus, the new offset becomes “1”.

The command determining part 436 determines whether there are any function data which have not yet been obtained in the function setting data 500 (Step S308). As shown in FIG. 5, since the function setting data 500 include duplex printing function data (data related to the duplex printing function) as the second function data, the Steps S302-S307 are performed on the duplex printing function in the same manner as the staple function.

In the DEVMODE structure 900e of FIG. 9E, since a DEVMODE value “1” is written in the space 94 subsequent to the space 92, the command determining part 436 acquires (obtains) the process contents associated with the DEVMODE value “1” (in this example, choice “right-bind”) by referring to the second function data 520 and determines the command “DUPLEX-RIGHTBIND” as the command associated to the choice “right-bind”.

Furthermore, the function setting data 500 include password function data (data related to the password function) as the third function data. Thus, the Steps S302-S307 are performed on the password function in the same manner as the staple function. In the DEVMODE structure 900e of FIG. 9E, since a DEVMODE value “ABCDEFGH” is written in the space 96 subsequent to the space 94, the command determining part 436 acquires (obtains) the process contents associated to the DEVMODE value “ABCDEFGH” by referring to the third function data 530. Since the password function is set with a character string including input alphabet letters, the command determining part 436 determines the command “PASSWORD=ABCDEFGH” as the command including the character string “ABCDEFGH”.

Furthermore, the function setting data 500 includes watermark printing function data (data related to the watermark printing function) as the fourth function data. Thus, the Steps S302-S307 are performed on the watermark printing function in the same manner as the staple function. In the DEVMODE structure 900e of FIG. 9E, since a DEVMODE value “1” is written in the space 98 subsequent to the space 96, the command determining part 436 acquires (obtains) the process contents associated to the DEVMODE value “1” (in this example, choice “on”) by referring to the fourth function data 540 and determines the command “WATERMARK=ON” as the command associated to the choice “on”.

Accordingly, printer interpretable commands can be determined according to the process contents allocated to the DEVMODE structure 900e.

Hence, with the above-described data processing apparatus (computer) according to an embodiment of the present invention, even in a case where a device driver is already installed in an apparatus (e.g., printer), data which can be processed by the apparatus can be generated in correspondence to changes of a function(s) of the apparatus without having to re-install the device driver by providing a space in a data structure defined by an OS (e.g., DEVMODE structure) for enabling data to be added to the space and reserving the space for enabling process contents set to a function of the apparatus to be written in the space.

### Second Embodiment

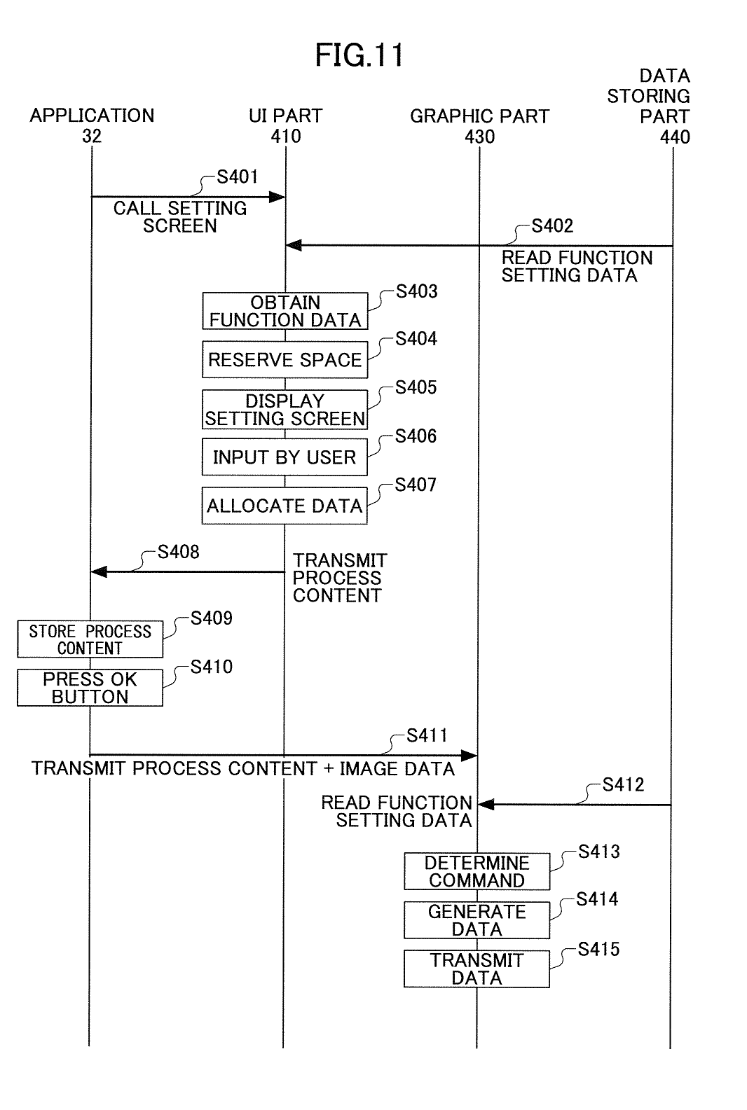

With reference to the sequence diagram of FIG. 11, an operation of the computer 10 is described in a case where process contents which are set by the user from the setting screen are used when generating data that can be processed by the printer 12.

As an exemplary case of using process contents which are set by the user with the setting screen, there is a case where a user makes a request to call a setting screen by clicking a “property” button on a printing setting screen of an application operable with Windows (registered trademark) for displaying a setting screen (e.g., property screen) for setting, for example, printing conditions of the printer 12 to the printer driver 36. In this case, a setting screen calling request is transmitted from the application 32 to the UI part 410 of the printer driver 36 (Step S401).

Upon receiving the request from the application 32, the UI part 410 uses the first function setting data reading part 414 to read function setting data 500 (see FIG. 5) from the function setting data DB 442 of the data storing part 440 (Step S402). Then, the UI part 410 uses the data structure allocating part 420 to obtain function data related to various functions from the function setting data 500 read by the first function setting data reading part 414 (Step S403). Then, the UI part 410 uses the data structure allocating part 420 to obtain the data size necessary for writing process contents of functions obtained from the function data to the DEVMODE structure and reserve a space corresponding to the data size in the DEVMODE structure (Step S404).

Then, the UI part 410 uses the display part 412 to obtain one or more functions names from the function setting data 500 read by the first function setting data reading part 414 along with obtaining a choice in a case where the function is set by selecting one or more choices, build a setting screen based on the obtained function name data and choice data, and display the setting screen on a display apparatus (e.g., monitor) (Step S405). Then, the user uses an input apparatus (e.g., keyboard, not shown) to input setting data for setting each function of the printer 12 based on the setting screen displayed by the display part 412 (Step S406). The setting data input by the user are transmitted to the display part 412 via the input part 418 and set as process contents of the printer 12. Then, the UI part 410 uses the data structure allocating part 420 to allocate data of the process contents set with the display part to the DEVMODE structure (Step S407) as described with FIGS. 9A-9E.

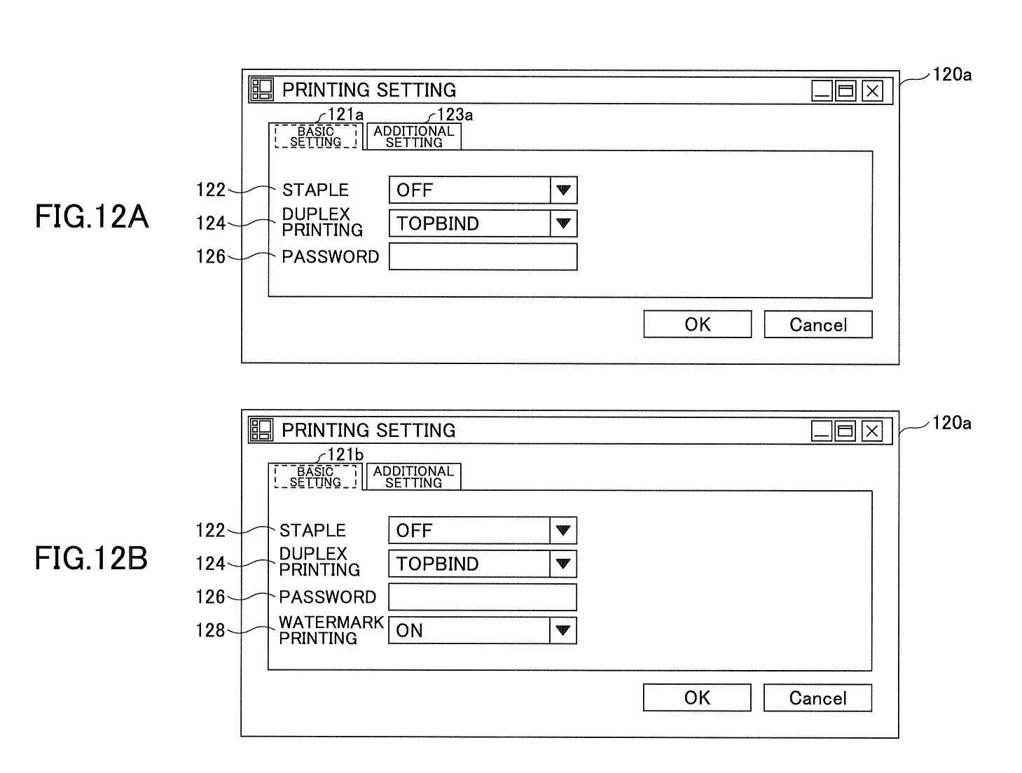

Then, the UI part 410 transmits the DEVMODE structure including the process contents data allocated by the data structure allocating part 420 to the application 32 (Step S408). Then, the application 32 stores the DEVMODE structure transmitted from the UI part 410 (Step S409). Then, a printing request is transmitted from the application 32 to the printer driver 36 when the user presses an “OK” button (See FIG. 12) displayed in the printing setting screen (Step S410). At the same time of transmitting the printing request or after transmitting the printing request, the application 32 transmits the DEVMODE structure stored therein and image data browsed or generated by the application 32 to the graphic part 430 of the printer driver 36 (Step S411).

The graphic part 430 uses the second function setting data reading part 432 to read function setting data 500 from the function setting data DB 442 of the data storing part 440 (Step S412). Then, the graphic part 430 uses the command determining part 436 to determine a printer interpretable command corresponding to the data of the process contents allocated to the DEVMODE structure obtained from the application 32 by referring to the function setting data 500 read by the second function setting data reading part 432 (Step S413). Then, the graphic part 430 uses the data generating part 438 to generate printer processable data from the image data obtained from the application 32 and data of process contents allocated to the DEVMODE structure according to the command determined by the command determining part 436 (Step S414). Then, the graphic part 430 transmits the data generated by the data generating part 438 to the printer 12 via the spooler 38 (see FIG. 3) (Step S415).

Thereby, the UI part 410 can read out function setting data from the function setting data DB 442 whenever a setting screen calling request is transmitted from the application 32 to the UI part 410 of the printer driver 36.

For example, in a case of adding a watermark printing function where the computer (data processing apparatus) 10 is connected to a printer having a staple function, a duplex printing function, and a password function, the function data related to the watermark printing function can be added to function setting data stored in the function setting data DB 442 by direct input from the user, reading from a recording medium, obtaining from a predetermined server, or obtaining from an apparatus connected to the computer 10. As a result, function setting data 500 as shown in FIG. 5 are obtained. Thus, in correspondence with the addition of the watermark printing function to the printer 12, the function setting data 500 including the added function data 540 of the watermark printing function are stored in the function setting data DB 442. Accordingly, the display part 412 of the UI part 410 can display a setting screen that corresponds to the addition of a function(s) of the printer 12.

FIGS. 12A and 12B show examples of the setting screen of the printer 12 according to an embodiment of the present invention. FIG. 12A shows an example of a setting screen prior to the addition of a function (hereinafter referred to as “former setting screen 120a” for the sake of convenience), and FIG. 12B shows an example of a setting screen subsequent to addition of a watermark printing function (hereinafter referred to as “latter setting screen 120b” for the sake of convenience).

The former setting screen 120a includes a basic setting tab 121a and an additional setting tab 123a. In this example, the basic setting tab 121a is displayed on the front side. In the basic setting tab 121a, setting items 122, 124, and 126 which include function names and spaces for inputting setting data are displayed in a vertical order. The setting items 122, 124, and 126 are items for setting process contents corresponding to the staple function, the duplex printing function, and the password function.

After the watermark printing function is added to the printer 12 having the settings shown in FIG. 12A, function data related to the watermark printing function are also added to the function setting data of the computer 10. Accordingly, the display part 412 of the UI part 410 displays the latter setting screen 120b in a manner where the basic setting tab 121a of the former setting screen 120a is added with an item 128 for setting the watermark printing function.

Accordingly, with the above-described data processing apparatus (computer) according to an embodiment of the present invention, even in a case where a printer driver is already installed, a setting screen corresponding to function change of the printer can be displayed without having to re-install the printer driver by using function setting data obtained upon displaying a printing setting screen of the printer.

### Third Embodiment

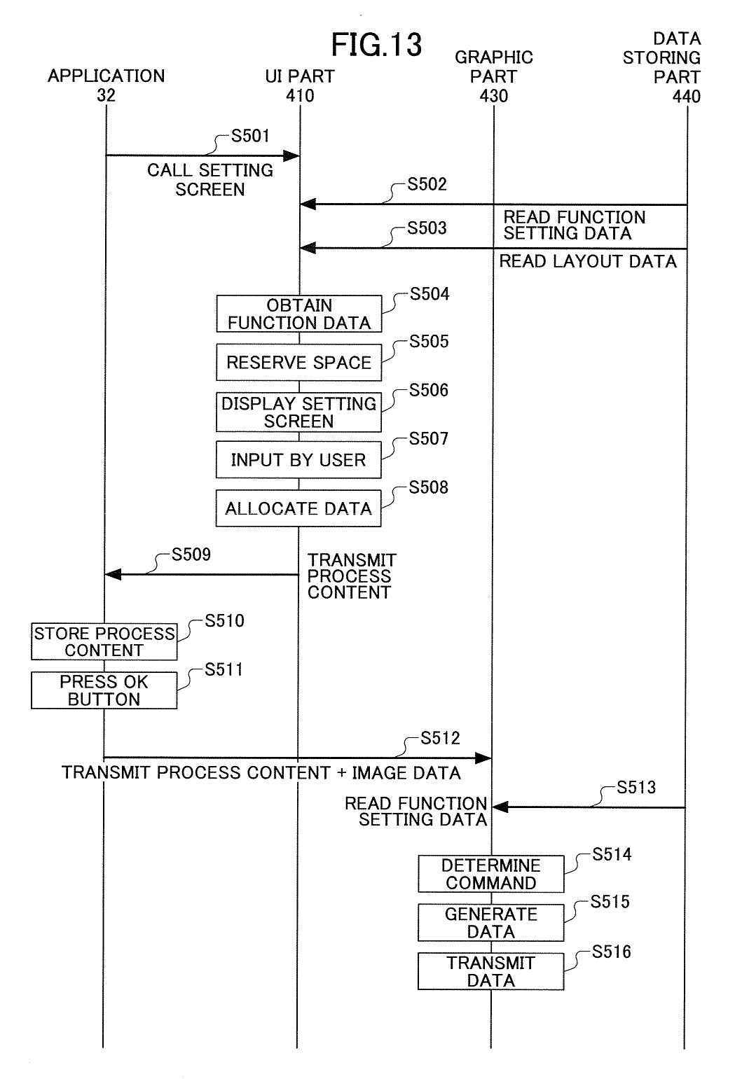

With reference to the sequence diagram of FIG. 13, an operation of the computer 10 is described in a case where the computer 10 can change the layout of the setting screen displayed in a manner described in the second embodiment of the present invention.

In a case where the user makes a request to set the printer 12, a setting screen calling request is transmitted from the application 32 to the UI part 410 of the printer driver 36 (Step S501).

Upon receiving the request from the application 32, the UI part 410 uses the first function setting data reading part 414 to read function setting data 500 (see FIG. 5) from the function setting data DB 442 of the data storing part 440 (Step S502). Then, the UI part 410 uses the layout data reading part 416 to read layout data 600 (see FIG. 6) corresponding to the function setting data 500 obtained in Step S502 from the layout data DB 444 of the data storing part 440 (Step S503).

Then, the UI part 410 uses the data structure allocating part 420 to obtain function data related to various functions from the function setting data 500 read by the first function setting data reading part 414 (Step S504). Then, the UI part 410 uses the data structure allocating part 420 to obtain the data size necessary for writing process contents of functions obtained from the function data to the DEVMODE structure and reserve a space corresponding to the data size in the DEVMODE structure (Step S505).

Then, the UI part 410 uses the display part 412 to obtain one or more functions names from the function setting data 500 read by the first function setting data reading part 414 along with obtaining a choice in a case where the function is set by selecting one or more choices, build a setting screen based on the obtained function name data and choice data, and display the setting screen on a display apparatus (e.g., monitor) (Step S506). Then, the user uses an input apparatus (e.g., keyboard, not shown) to input setting data for setting each function of the printer 12 based on the setting screen displayed by the display part 412 (Step S507). The setting data input by the user are transmitted to the display part 412 via the input part 418 and set as process contents of the printer 12. Then, the UI part 410 uses the data structure allocating part 420 to allocate data of the process contents set with the display part to the DEVMODE structure (Step S508) as described with FIGS. 9A-9E.

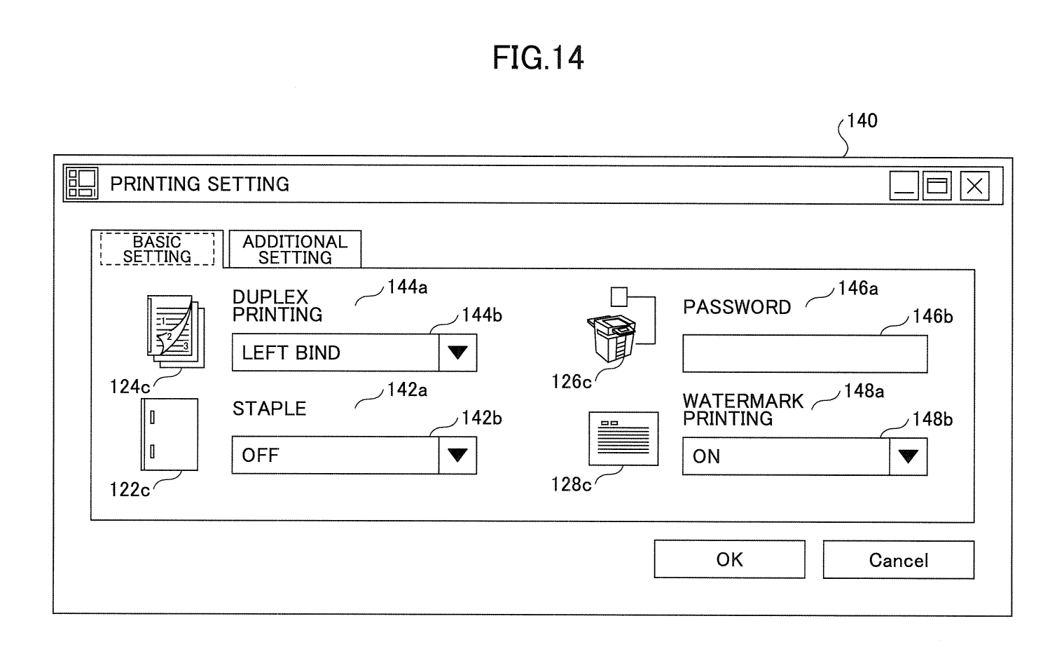

Then, the UI part 410 transmits the DEVMODE structure including the process contents data allocated by the data structure allocating part 420 to the application 32 (Step S509). Then, the application 32 stores the DEVMODE structure transmitted from the UI part 410 (Step S510). Then, a printing request is transmitted from the application 32 to the printer driver 36 when the user presses an “OK” button (See FIG. 14) displayed in the printing setting screen (Step S511). At the same time of transmitting the printing request or after transmitting the printing request, the application 32 transmits the DEVMODE structure stored therein and image data browsed or generated by the application 32 to the graphic part 430 of the printer driver 36 (Step S512).

The graphic part 430 uses the second function setting data reading part 432 to read function setting data 500 from the function setting data DB 442 of the data storing part 440 (Step S513). Then, the graphic part 430 uses the command determining part 436 to determine a printer interpretable command corresponding to the data of the process contents allocated to the DEVMODE structure obtained from the application 32 by referring to the function setting data 500 read by the second function setting data reading part 432 (Step S514). Then, the graphic part 430 uses the data generating part 438 to generate printer processable data from the image data obtained from the application 32 and data of process contents allocated to the DEVMODE structure according to the command determined by the command determining part 436 (Step S515). Then, the graphic part 430 transmits the data generated by the data generating part 438 to the printer 12 via the spooler 38 (see FIG. 3) (Step S516).

The operation of the computer 10 shown in FIG. 13 is different from the operation of the computer 10 of the second embodiment shown in FIG. 11 in that the UI part 410 reads out layout data along with function setting data from the data storing part 440.

For example, in a case of adding a watermark printing function where the computer (data processing apparatus) 10 is connected to a printer having a staple function, a duplex printing function, and a password function, layout data related to the watermark printing function can be added to layout data stored in the layout data DB 442 by direct input from the user, reading from a recording medium, obtaining from a predetermined server, or obtaining from an apparatus connected to the computer 10. As a result, layout data 600 as shown in FIG. 6 are obtained. Thus, in correspondence with the addition of the watermark printing function to the printer 12, the layout data 600 including the added layout data 650 of the watermark printing function are stored in the layout data DB 444. Accordingly, the display part 412 of the UI part 410 can arrange items for setting the process contents of each function of the printer defined by the function data included in the function setting data stored in the data storing part 440 based on the layout data 600.

FIG. 14 shows an example of a setting screen of the printer 12 according to an embodiment of the present invention. FIG. 14 shows the setting screen 140 in a case where a watermark printing function is added later-on in the printer 12. The setting screen 140 has four types of setting items including function names 142a, 144a, 146a, 148a, setting data input spaces 142b, 144b, 146b, 148b, and function images 142c, 144c, 146c, 148c. In this example, the setting items are arranged in two rows vertically and horizontally and have item “staple”, item “duplex printing”, item “password”, and item “watermark printing” arrange in this order from a clockwise direction.

In comparing the setting screen 140 of this embodiment with the setting screen 120b of the above-described second embodiment, since the setting screen 140 is configured based on the layout data, function image can be added to the setting items, function names, input spaces and function images, layout of the setting items can be changed (See FIG. 12B).

Accordingly, with the above-described data processing apparatus (computer) according to an embodiment of the present invention, even in a case where a printer driver is already installed, a setting screen corresponding to function change of the printer can be displayed without having to re-install the printer driver by using function setting data along with layout data obtained upon displaying a printing setting screen of the printer.

### Fourth Embodiment

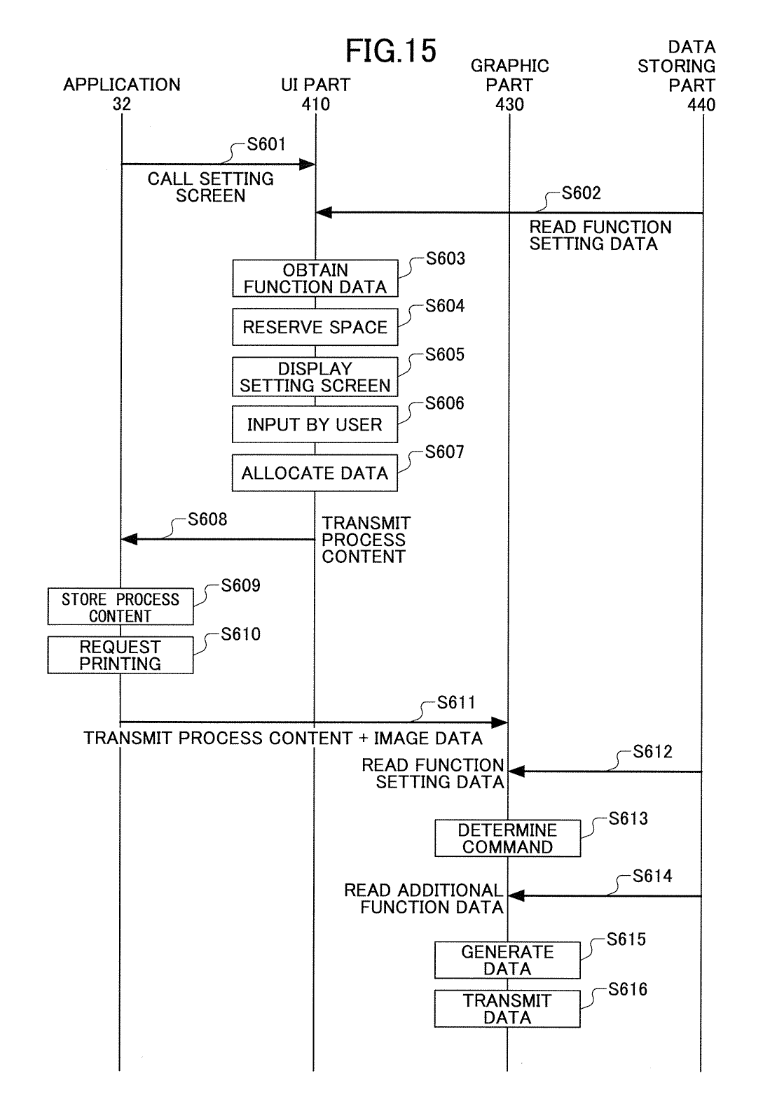

With reference to the sequence diagram of FIG. 15, an operation of the computer 10 is described in a case where the computer 10 can execute a function(s) which is initially executed by the printer side.

In a case where the user makes a request to set the printer 12, a setting screen calling request is transmitted from the application 32 to the UI part 410 of the printer driver 36 (Step S601).

Upon receiving the request from the application 32, the UI part 410 uses the first function setting data reading part 414 to read function setting data 500 (see FIG. 5) from the function setting data DB 442 of the data storing part 440 (Step S602). Then, the UI part 410 uses the data structure allocating part 420 to obtain function data related to various functions from the function setting data 500 read by the first function setting data reading part 414 (Step S603). Then, the UI part 410 uses the data structure allocating part 420 to obtain the data size necessary for writing process contents of functions obtained from the function data to the DEVMODE structure and reserve a space corresponding to the data size in the DEVMODE structure (Step S604).

Then, the UI part 410 uses the display part 412 to obtain one or more functions names from the function setting data 500 read by the first function setting data reading part 414 along with obtaining a choice in a case where the function is set by selecting one or more choices, build a setting screen based on the obtained function name data and choice data, and display the setting screen on a display apparatus (e.g., monitor) (Step S605). Then, the user uses an input apparatus (e.g., keyboard, not shown) to input setting data for setting each function of the printer 12 based on the setting screen displayed by the display part 412 (Step S606). The setting data input by the user are transmitted to the display part 412 via the input part 418 and set as process contents of the printer 12. Then, the UI part 410 uses the data structure allocating part 420 to allocate data of the process contents set with the display part to the DEVMODE structure (Step S607) as described with FIGS. 9A-9E.

Then, the UI part 410 transmits the DEVMODE structure including the process contents data allocated by the data structure allocating part 420 to the application 32 (Step S608). Then, the application 32 stores the DEVMODE structure transmitted from the UI part 410 (Step S609). Then, a printing request is transmitted from the application 32 to the printer driver 36 when the user presses an “OK” button (See FIG. 12) displayed in the printing setting screen (Step S610). At the same time of transmitting the printing request or after transmitting the printing request, the application 32 transmits the DEVMODE structure stored therein and image data browsed or generated by the application 32 to the graphic part 430 of the printer driver 36 (Step S611).

The graphic part 430 uses the second function setting data reading part 432 to read function setting data 500 from the function setting data DB 442 of the data storing part 440 (Step S612). Then, the graphic part 430 uses the command determining part 436 to determine a printer interpretable command corresponding to the data of the process contents allocated to the DEVMODE structure obtained from the application 32 by referring to the function setting data 500 read by the second function setting data reading part 432 (Step S613).

After determining the command, the graphic part 430 uses the additional function data reading part 434 for reading addition function data from the additional function data DB 446 of the data storing part 440 (Step S614). Then, the graphic part 430 uses the data generating part 438 to generate printer processable data from the image data obtained from the application 32 and data of process contents allocated to the DEVMODE structure according to the command determined by the command determining part 436 and the additional data read by the additional function data reading part 434 (Step S615). Then, the graphic part 430 transmits the data generated by the data generating part 438 to the printer 12 via the spooler 38 (see FIG. 3) (Step S616).

The operation of the computer 10 shown in FIG. 15 is different from the operation of the computer 10 of the second embodiment shown in FIG. 11 in that the UI part 410 reads out additional function data from the from the data storing part 440 after determining the command and generates printer processable data according to not only the command determined by the command determining part 436 but also the additional data read by the additional function data reading part 434.

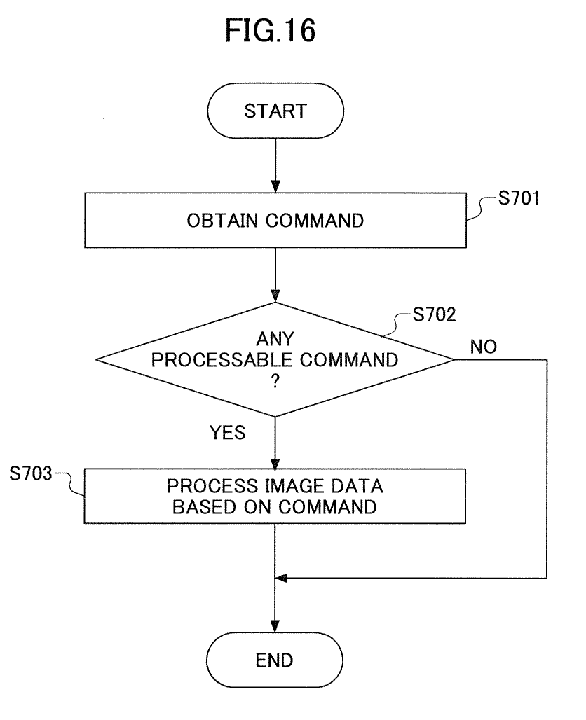

Next, an operation of generating data based on the additional function data is described with reference to FIG. 16.

After additional function data are read by the additional function data reading part 434 in Step S614 of FIG. 15, the data generating part 438 obtains the command determined by the command determining part 436 in Step S614 (S701). Then, the data generating part 438 determines whether the obtained command includes any commands that can be executed based on the additional function data (Step S702).

In a case where there is a command that can be executed (Yes in Step S702), the data generating part 438 processes image data obtained from the application 32 based on the command (Step S703). In a case where there is no command that can be executed (No in Step S702), the data generating part 438 ends the data generating operation based on additional function data.

The additional function data includes a program enabling the printer driver 36 to execute commands in the same manner as the printer 12. For example, in a case where the computer 10 is installed with the printer driver 36 including additional function data enabling execution of the watermark printing function and connected to a printer having the staple function, the duplex printing function, and the password function but has no watermark printing function, the function setting data stored in the function setting data DB 442 of the printer driver 36 include the functions of the printer (i.e. staple function, duplex printing function, password function) and the function that can be executed by the printer driver 63 (i.e. watermark printing function). As a result, the function setting data 500 shown in FIG. 5 can be obtained. Accordingly, the display part 412 of the UI part 410 displays a basic setting tab (See FIG. 12) for setting functions executed on the printer side and an additional setting tab (See FIG. 12) for setting functions that can be executed on the printer driver side on the setting screen based on the function setting data 500. Then, the command determining part 436 determines a printer interpretable command corresponding to the process contents of the functions set by the user via the setting screen. The command determined by the command determining part 436 includes a command of the watermark printing function to be executed in the printer driver 36. The data generating part 438 executes the command of the watermark printing function based on the additional function data and generates data that has watermark data added to the image data obtained from the application 32.

Then, in a case where the watermark printing function is added to the printer 12, the additional function data related to the watermark printing function may be deleted from the printer driver 36.

Accordingly, with the above-described data processing apparatus (computer) according to an embodiment of the present invention, even in a case where a printer driver is already installed, a function not installed in the printer can be added to the computer since functions to be initially executed on the printer side can be executed on the computer side based on the additional function data.

### Fifth Embodiment

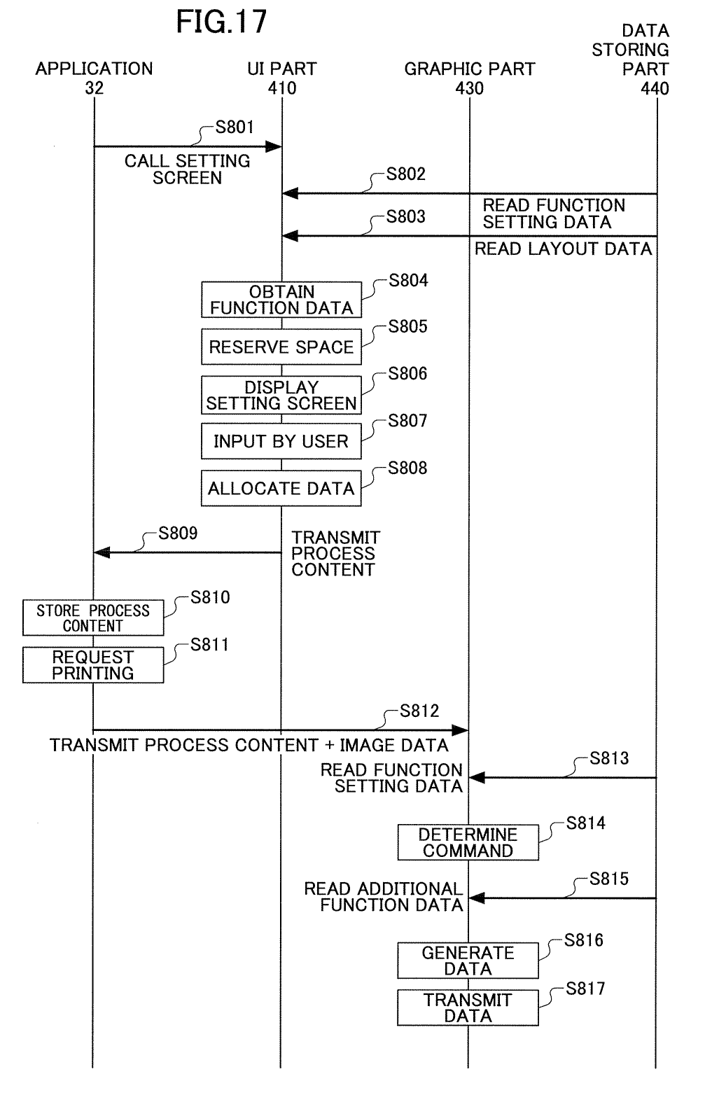

With reference to the sequence diagram of FIG. 17, an operation of the computer 10 is described in a case where the computer 10 can change the layout of the setting screen displayed in a manner described in the second embodiment of the present invention and can execute a function(s) which is initially executed by the printer side.

Upon receiving the request from the application 32, the UI part 410 uses the first function setting data reading part 414 to read function setting data 500 (see FIG. 5) from the function setting data DB 442 of the data storing part 440 (Step S802). Then, the UI part 410 uses the layout data reading part 416 to read layout data 600 (see FIG. 6) corresponding to the function setting data 500 obtained in Step S802 from the layout data DB 444 of the data storing part 440 (Step S803).

Then, the UI part 410 uses the data structure allocating part 420 to obtain function data related to various functions from the function setting data 500 read by the first function setting data reading part 414 (Step S804). Then, the UI part 410 uses the data structure allocating part 420 to obtain the data size necessary for writing process contents of functions obtained from the function data to the DEVMODE structure and reserve a space corresponding to the data size in the DEVMODE structure (Step S805).

Then, the UI part 410 uses the display part 412 to obtain one or more function names from the function setting data 500 read by the first function setting data reading part 414 along with obtaining a choice in a case where the function is set by selecting one or more choices, builds a setting screen based on the obtained function name data and choice data, and displays the setting screen on a display apparatus (e.g., monitor) (Step S806). Then, the user uses an input apparatus (e.g., keyboard, not shown) to input setting data for setting each function of the printer 12 based on the setting screen displayed by the display part 412 (Step S807). The setting data input by the user are transmitted to the display part 412 via the input part 418 and set as process contents of the printer 12. Then, the UI part 410 uses the data structure allocating part 420 to allocate data of the process contents set with the display part to the DEVMODE structure (Step S808) as described with FIGS. 9A-9E.

Then, the UI part 410 transmits the DEVMODE structure including the process contents data allocated by the data structure allocating part 420 to the application 32 (Step S809). Then, the application 32 stores the DEVMODE structure transmitted from the UI part 410 (Step S810). Then, a printing request is transmitted from the application 32 to the printer driver 36 when the user presses an “OK” button (See FIG. 14) displayed in the printing setting screen (Step S811). At the same time of transmitting the printing request or after transmitting the printing request, the application 32 transmits the DEVMODE structure stored therein and image data browsed or generated by the application 32 to the graphic part 430 of the printer driver 36 (Step S812).

The graphic part 430 uses the second function setting data reading part 432 to read function setting data 500 from the function setting data DB 442 of the data storing part 440 (Step S813). Then, the graphic part 430 uses the command determining part 436 to determine a printer interpretable command corresponding to the data of the process contents allocated to the DEVMODE structure obtained from the application 32 by referring to the function setting data 500 read by the second function setting data reading part 432 (Step S814).

After determining the command, the graphic part 430 uses the additional function data reading part 434 for reading addition function data from the additional function data DB 446 of the data storing part 440 (Step S815). Then, the graphic part 430 uses the data generating part 438 to generate printer processable data from the image data obtained from the application 32 and data of process contents allocated to the DEVMODE structure according to the command determined by the command determining part 436 and the additional data read by the additional function data reading part 434 (Step S816). Then, the graphic part 430 transmits the data generated by the data generating part 438 to the printer 12 via the spooler 38 (see FIG. 3) (Step S817).

The operation of the computer 10 shown in FIG. 17 is different from the operation of the computer 10 of the second embodiment shown in FIG. 11 in that the UI part 410 reads out layout data in addition to function setting data from the data storing part 440 when a setting screen call request is transmitted from the application 32 to the UI part 410 of the printer driver 32 and that the UI part 410 reads out additional function data from the from the data storing part 440 after determining the command and generates printer processable data according to not only the command determined by the command determining part 436 but also the additional data read by the additional function data reading part 434. The operation of the computer according to the fifth embodiment of the present invention is realized by combining the operations of the computer of the third and fourth embodiments of the present invention.

Accordingly, with the above-described data processing apparatus (computer) according to an embodiment of the present invention, even in a case where a printer driver is already installed, a function not installed in the printer can be added to the computer since functions to be initially executed on the printer side can be executed on the computer side based on the additional function data. In addition, even in a case where a printer driver is already installed, a setting screen corresponding to function change of the printer can be displayed without having to re-install the printer driver by using function setting data along with layout data obtained upon displaying a printing setting screen of the printer.

### Modified Example

Although the above-described embodiments of the present invention are explained by using a printer driver as an example of a device driver, the present invention may be applied to other device drivers (e.g., scanner driver, PC-FAX driver) as long as it is software for converting a command from an application into data that can be processed by a device.

Furthermore, although the above-described embodiments of the present invention are explained by using a program stored in a hard disk (HDD) or a memory (e.g., ROM) of a data processing apparatus, the present invention may be realized by using hardware of a data processing apparatus.

Furthermore, although the above-described embodiments of the present invention are explained by using a device driver or a module having functions/configurations similar to the device driver, the present invention may be applied to an application itself.

Further, the present invention is not limited to these embodiments, but variations and modifications may be made without departing from the scope of the present invention.

The present application is based on Japanese Priority Application Nos. 2006-250038 and 2007-152025 filed on Sep. 14, 2006 and Jun. 7, 2007, respectively, with the Japanese Patent Office, the entire contents of which are hereby incorporated by reference.

What is claimed is:

1. A data processing apparatus for generating data that can be processed by a printing apparatus, the data processing apparatus comprising:
a data storing part for storing function setting data related to a function of the printing apparatus;
a data structure allocating part for obtaining the function setting data from the data storing part, reserving a first space in a data structure configured to store printing settings of the printing apparatus therein, and allocating a printing setting value to the space based on the obtained function setting data; and
a data generating part for generating data processable for the printing apparatus based on the printing setting value allocated in the data structure by the data structure allocating part by referring to the function setting data stored in the data storing part.

2. The data processing apparatus as claimed in claim 1, wherein the function setting data includes function data of the printing apparatus and data-size data of a command corresponding to the printing setting value, wherein the first space is reserved for accommodating the command corresponding to the printing setting value in accordance with the data-size data.

3. The data processing apparatus as claimed in claim 1, wherein the data structure includes a second space to which data can be added, wherein the data structure allocating part reserves the first space in the second space of the data structure.

4. The data processing apparatus as claimed in claim 1, further comprising:
a display part for displaying a setting screen based on the function setting data stored in the data storing part;
wherein the printing setting value is an input value input to the setting screen.

5. The data processing apparatus as claimed in claim 4, wherein the data storing part is also for storing layout data for determining the layout of the setting screen, wherein the setting screen is built by the display part based on the layout data.

6. The data processing apparatus as claimed in claim 1, wherein the data storing part is also for storing additional function data for enabling the data processing apparatus to execute a function of the printing apparatus, wherein the data generating part processes image data included in the processable data based on the additional function data.

7. The data processing apparatus as claimed in claim 1, wherein the function setting data are obtained by at least one of direct input from a user, reading from a recording medium, obtaining from a predetermined server, and obtaining from the printing apparatus.

8. A recording medium on which a program is recorded for causing a data processing apparatus to execute a data processing method for generating data that can be processed by a printing apparatus, the data processing method comprising the steps of:
a) storing function setting data related to a function of the printing apparatus;
b) obtaining the function setting data from the data storing part, reserving a first space in a data structure configured to store printing settings of the printing apparatus therein, and allocating a printing setting value to the space based on the obtained function setting data; and
c) generating data processable for the printing apparatus based on the printing setting value allocated in the data structure by the data structure allocating part by referring to the function setting data stored in the data storing part.

9. The recording medium as claimed in claim 8, wherein the function setting data includes function data of the printing apparatus and data-size data of a command corresponding to the printing setting value, wherein the first space is reserved for accommodating the command corresponding to the printing setting value in accordance with the data-size data.

10. The recording medium as claimed in claim 8, wherein the data structure includes a second space to which data can be added, wherein step b) includes a step of reserving the first space in the second space of the data structure.

11. The recording medium as claimed in claim 8, further comprising a step of:
d) displaying a setting screen based on the function setting data stored in step a);
wherein the printing setting value is an input value input to the setting screen.

12. The recording medium as claimed in claim 11, wherein step a) also includes a step of storing layout data for determining the layout of the setting screen, wherein the setting screen is built in step d) based on the layout data.

13. The recording medium as claimed in claim 8, wherein step a) also includes a step of storing additional function data for enabling the data processing apparatus to execute a function of the printing apparatus, wherein step c) includes a step of processing image data included in the processable data based on the additional function data.

14. The recording medium as claimed in claim 8, wherein the function setting data are obtained by at least one of direct input from a user, reading from a recording medium, obtaining from a predetermined server, and obtaining from the printing apparatus.
